(19) United States
(12) Patent Application Publication
(10) Pub. No.: US 2020/0050182 A1
(43) Pub. Date: Feb. 13, 2020

(54) AUTOMATED ANOMALY PRECURSOR DETECTION

(71) Applicant: NEC Laboratories America, Inc., Princeton, NJ (US)

(72) Inventors: Wei Cheng, Princeton Junction, NJ (US); Dongkuan Xu, State College, PA (US); Haifeng Chen, West Windsor, NJ (US); Masanao Natsumeda, Princeton Junction, NJ (US)

(21) Appl. No.: 16/520,632

(22) Filed: Jul. 24, 2019

Related U.S. Application Data
(60) Provisional application No. 62/715,448, filed on Aug. 7, 2018.

(51) Int. Cl. G05B 23/02; G06N 3/08; G06F 16/22

(52) U.S. Cl. CPC G05B 23/0218; G05B 2219/32287; G06F 16/22; G06N 3/08

(57) ABSTRACT

Systems and methods are provided for detecting anomaly precursor events. The methods include organizing time series data into an input data structure that maintains an association between instances identified in the time series data and respective sensors. Additionally, the methods include calculating an instance attention value for each instance of at least one instance; calculating a sensor attention value for each sensor of the respective sensors; and identifying correlations between multiple sensors of the respective sensors based on the instance attention value and sensor attention value to identify a precursor event candidate based on a relationship between the instances and the respective sensors. Also, the method includes identifying an impending anomaly candidate from a database of historical anomalies based on the precursor event candidate. Further, the method includes generating an alert indicating an impending anomaly event identifying a type of impending anomaly event based on the database of historical anomalies.

### RELATED APPLICATION INFORMATION

This application claims priority to Provisional Patent Application No. 62/715,448, filed on Aug. 7, 2018, incorporated herein by reference in its entirety.

### BACKGROUND

### Technical Field

The present invention relates to anomaly detection in complex systems, and more particularly to automated anomaly precursor detection.

### Description of the Related Art

Large, complex systems, such as chemical production systems, powerplants, datacenters, etc., may need constant monitoring to ensure that system uptime remains at acceptable levels and avoid system failures. Currently, such systems are provided with various sensors that provide operational information to a technician, operator, or information technology officer, who is tasked with monitoring and initiating any corrective action to maintain operation of the system within preset parameters. Monitoring behaviors of these large-scale systems generates massive time series data, such as the readings of sensors distributed in a power plant, and the flow intensities of system logs from the cloud computing facilities. The unprecedented growth of monitoring data increases the demand for automatic and timely detection of incipient anomalies as well as precise discovery of precursor symptoms.

### SUMMARY

According to an aspect of the present invention, method is provided for detecting anomaly precursor events. The method includes organizing time series data into an input data structure stored in memory blocks. The input data structure maintains an association between instances identified in the time series data and respective sensors. Additionally, the method includes calculating an instance attention value for each instance of at least one instance; calculating a sensor attention value for each sensor of the respective sensors; and identifying correlations between multiple sensors of the respective sensors based on the instance attention value and sensor attention value to identify a precursor event candidate based on a learned relationship between the instances and the respective sensors. The multiple sensors are associated with the precursor event candidate. Also, the method includes identifying an impending anomaly candidate from a database of historical anomalies. The impending anomaly candidate being identified based on the precursor event candidate. Further, the method includes generating an alert indicating an impending anomaly event. The alert identifies a type of impending anomaly event based on the database of historical anomalies.

According to another aspect of the present invention, a system is provided for anomaly precursor detection. The system includes a data receiving circuit configured to receive time series data from a plurality of sensors in substantially real-time; a buffer storage circuit configured to store the time series data from the plurality of sensors received via the data receiving circuit; and a processor device. The processor device is configured to organize time series data into an input data structure stored in memory blocks. The input data structure maintains an association between instances identified in the time series data and respective sensors. Also, the processor device analyzes the input data, using a trained neural network that preserves associations between respective sensors and time series data, to identify a precursor event candidate based on a learned relationship between instances and respective sensors; and identifies an impending anomaly candidate from a database of historical anomalies. The impending anomaly candidate can be identified based on the precursor event candidate. Additionally, an alert can be generated, by the processor device, indicating an impending anomaly event. The alert identifying a type of the impending anomaly event based on the database of historical anomalies

According to yet another aspect of the present invention, a non-transitory computer readable storage medium is provided. The non-transitory computer readable storage medium includes a computer readable program for anomaly precursor detection that, when executed by a processor device, causes the processor device to the method of organizing time series data into an input data structure stored in memory blocks, the input data structure maintaining an association between instances identified in the time series data and respective sensors; analyzing the input data, using a trained neural network that preserves associations between respective sensors and time series data, to identify a precursor event candidate based on a learned relationship between instances and respective sensors; identifying an impending anomaly candidate from a database of historical anomalies, the impending anomaly candidate being identified based on the precursor event candidate; and generating an alert indicating an impending anomaly event, the alert identifying a type of the impending anomaly event based on the database of historical anomalies.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block representation of a neural network illustrating a high-level system/method for detecting anomaly precursor events, in accordance with an embodiment of the present invention;

FIG. 2A is a block representation illustrating a neural network for detecting anomaly precursor events, in accordance with an embodiment of the present invention;

FIG. 2B is a block representation illustrating a derivation of a cell updating matrix in accordance with an embodiment of the present invention;

FIG. 2C is a block representation illustrating gate calculation processes in accordance with an embodiment of the present invention;

FIG. 3 is a flow diagram illustrating a method for training a neural network implemented system for detecting anomaly precursor events, in accordance with an embodiment of the present invention;

FIG. 4 is a flow diagram illustrating a neural network implemented method for detecting anomaly precursor events, in accordance with an embodiment of the present invention;

FIG. 5 is a block diagram illustrating a system for detecting anomaly precursor events, in accordance with an embodiment of the present invention; and

FIG. 6 is a block diagram illustrating a dual attention mechanism in accordance with embodiments of the present invention.

### DETAILED DESCRIPTION OF PREFERRED EMBODIMENTS

Embodiments of the present invention utilize neural networks configured to receive tensorized time series data, e.g., a matrix, or other data structure, that can associate time series data with information identifying the sensor generating the data, to identify precursor events that are indicative of an impending system anomaly. Additionally, the neural network can maintain the association between the time series data and the sensor generating the data throughout the processing. By maintain this association, embodiments of the present invention can perform a correlation analysis on the tensorized time series data that can identify precursor events by analyzing the relationships between multiple sensors. Consequently, precursor events that involve multiple sensors can be readily detected using embodiments of the present invention.

Embodiments provide systems and methods for automatically detecting anomaly precursor events in systems. Detecting precursor events can be useful for early prediction of anomalies, which can effectively facilitate the circumvention of serious problems. For example, embodiments can be applied to detect anomaly precursor events in a chemical production system. Different sensors can be deployed in/on different equipment (components) of the system. In an example, multiple sensors and their signals can be monitored over time. The historical observation of multivariate time series data can be collected. As time progresses, some historical anomaly events of different types can be recorded. The anomaly events can be easily identified since the anomaly event can be readily detected.

The precursor events can be more difficult to detect since the events leading to an anomaly can present themselves as subtle changes in time series data from one or more sensors. Additionally, it is difficult to identify which sensors are involved in the precursor symptoms, especially for complex systems with a large number of sensors. Moreover, in addition to the temporal dynamics in the raw multivariate time series, the correlations (interactions) between pairs of time series (sensors) can be important elements for characterizing the system status. Thus, precursor events often go unnoticed.

By taking advantage of historical annotated anomaly events, embodiments of the present invention can infer precursor event features (such as, the particular sensor and reading), along with the exact timing of the precursor events, for different types of anomalies. By making use of inferred precursor event features, embodiments can predict, or anticipate, the same type of anomaly in the future.

Embodiments can detect anomaly precursor events by employing a deep multi-instance recurrent neural network with dual attention (MRDA). MRDA can locate and learn the representations of precursor events, and then uses the representations to detect precursor events in future time series data. In some embodiments, MRDA can detect both the time period and the sensor, or sensors, involved with an individual precursor event. To facilitate detection of the time and sensor involved in a precursor event, embodiments include a neural network, e.g., MRDA, that is configured to process the time series data that has been tensorized. Throughout the processing of the tensorized time series data, the neural network, in embodiments of the present invention, maintains the association between the time series data and the respective sensors generating the data. Moreover, in some embodiments, the neural network can include a correlation module that analyzes the relationship, and interactions, between the time series data from multiple sensors to identify precursor events.

As applied herein, the term “tensorized” refers to converting a time series data stream into a data structure that can associate the time series data with the sensor that generated the data. One such data structure is a matrix in which each row of the matrix corresponds to an individual sensor, and each column corresponds to a time instance. In an effort to simplify explanation of the operation, features and advantages of the present invention, embodiments herein describe tensorizing the time series data into a matrix. However, other data structures can be used as well, such as, for example, a multi-dimensional array without departing from the spirit of the present invention.

In embodiments of the present invention, precursor events can include events, e.g., sensor outputs, that are indicative of an imminent system anomaly. System anomalies can include system events that are outliers with respect to a desired steady-state range of operation. For example, in a chemical production plant, a system anomaly can be a leaking pipe. In another example, with respect to a datacenter, a system anomaly can be non-responsiveness of one or more computer systems or components. Additionally, a system anomaly can be an attempted cyberattack or unauthorized intrusion into a computer network.

In some embodiments, trained neural networks are employed to detect time and sensor location for precursor events associated with previously identified system anomalies. The trained neural network receives outputs from one or more sensors as inputs. Different weight values can be assigned to the various inputs based on the sensor type and/or location. Additionally, the assigned weight values can be adjusted based on the time period. For example, certain sensor outputs may predict an impending system anomaly at only certain times during the day, e.g., after work hours.

The trained neural network can be configured to output an alert message directed to a technician along with relevant sensor information when a precursor event is detected. The trained neural network can be configured to also provide suggested actions for correcting/preventing the predicted system anomaly. In this way, the present invention can prevent or moderate the effects of a system anomaly.

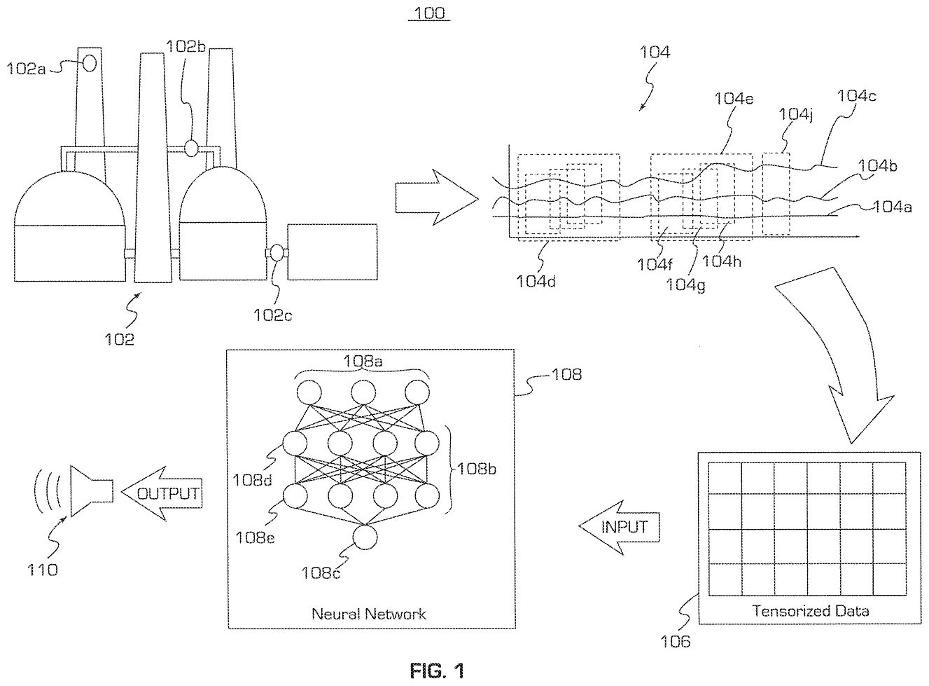

Referring now in detail to the figures in which like numerals represent the same or similar elements and initially to FIG. 1, an anomaly precursor detection system 100 is illustratively depicted in accordance with an embodiment of the present invention. A monitored system 102 is equipped with multiple sensors (e.g., sensor 102a, sensor 102b and sensor 102c). Each sensor 102a, 102b, 102c generates time series data 104 that is received by the anomaly precursor detection system 100, where the time series data 104 from the sensors 102a, 102b, 102c can be tensorized such that the time series data 104 from the sensors 102a, 102b, 102c can be collectively represented in a matrix 106. The matrix 106 can be fed through a neural network 108 trained to identify anomaly precursor events in the time series data 104. The anomaly precursor detection system 100 can include an alert system 110 that can issue an alert, notification or alarm, as appropriate, when an anomaly precursor event is identified.

The monitored system 102 can be any type of system that can be provided with sensors 102a, 102b, 102c configured to monitor relevant operational parameters. For example, the system 102 can be, for example, a waste treatment plant, a refinery, an electric power plant, automated factory, multiple computer and/or Internet of Things (IoT) devices in a network. In the case of a waste treatment plant, for example, a failure of a piece of equipment, e.g., a pump, mixer, etc., can be considered an anomaly in the context of an embodiment of the present invention. In the example system, changes in time series data received from temperature sensors, pressure sensors, and chemical sensors, for example, may indicate precursor events identifying the anomaly.

Alternatively, the system 102 can be operating systems and software applications executing within a computer. Sensors (either physical or software-based) can be employed to record memory usage, processor load, network load, disk access, temperature, etc., to identify software issues, such as, e.g., application crashes, or malicious activity.

A sensor 102a, 102b, 102c as understood in embodiments of the present invention can include any hardware or software component that can monitor and output time series data 104 regarding an operational parameter of a monitored system 102. The time series data 104 generated by the sensors 102a, 102b, 102c can be analog, digital or a combination of analog and digital signals.

The time series data 104 from the multiple sensors 102a, 102b, 102c can be provided to the anomaly precursor detection system 100 via a wired or wireless communication path. For example, the sensors 102a, 102b, 102c can be equipped with transmitters conforming to any of the IEEE 802 network protocols (e.g., Ethernet or Wi-Fi), Bluetooth, RS-232, etc. Alternatively, the sensors 102a, 102b, 102c can be configured to transmit data via one or more proprietary data protocols.

The anomaly precursor detection system 100 converts the time series data 104 into tensorized data 106, such that each row of an input matrix corresponds to an individual sensor 102a, 102b, 102c and each column corresponds to a time instance 104f, 104g, 104h. The tensorized data 106, in the form of the input matrix, is fed to an input layer 108a of a neural network 108. The tensorized data 106 enables the neural network 108 to individually identify the sensors 102a, 102b, 102c and associate the time series data 104 accordingly. Moreover, by having the sensors 102a, 102b, 102c individually identifiable, and addressable, the neural network 108 can be configured to assign different weightings in the hidden layer 108b to each sensor 102a, 102b, 102c, and consider the relationship (e.g., correlation) between sensors 102a, 102b, 102c to identify anomaly precursor events.

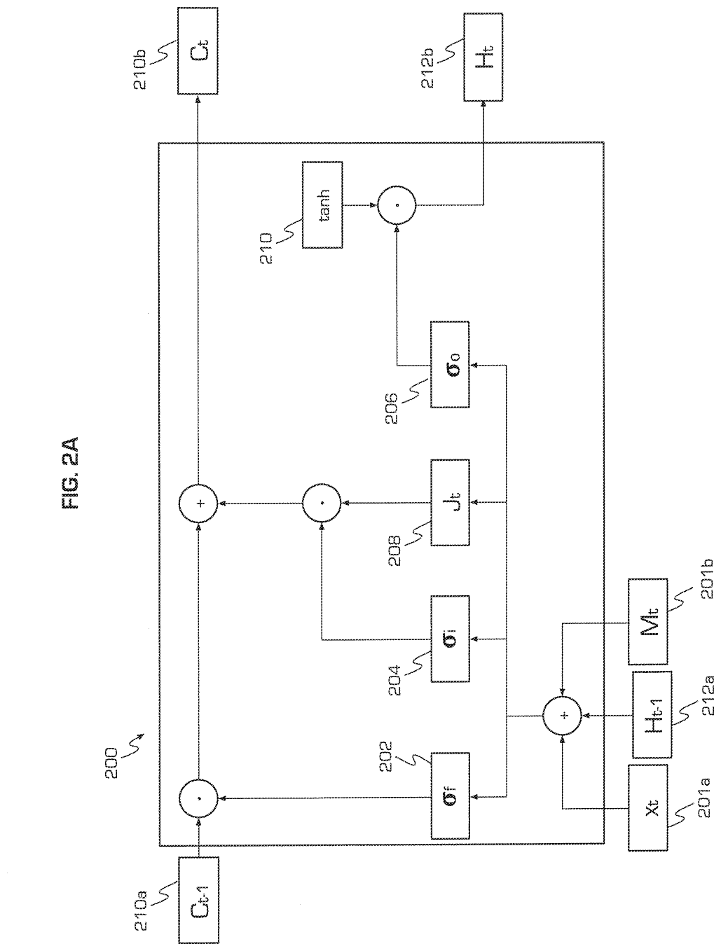

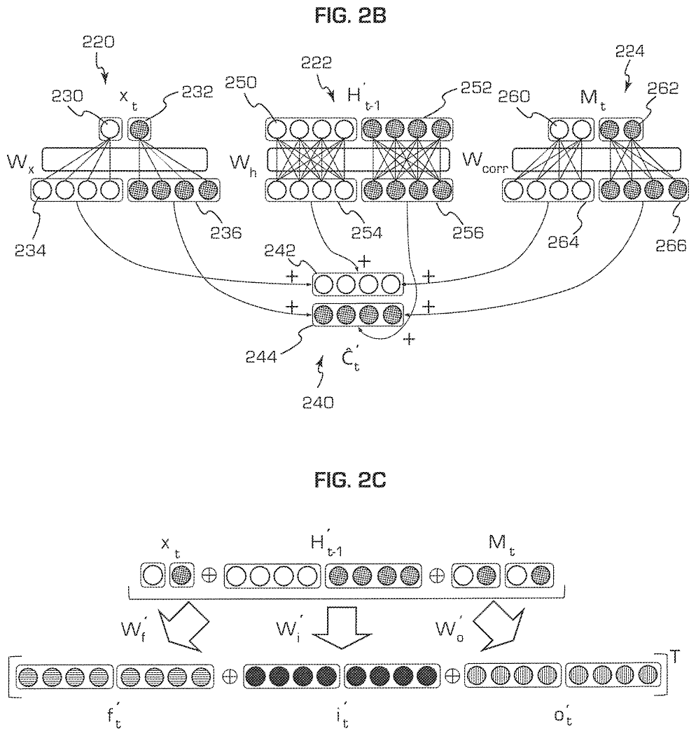

In an embodiment of the present invention, the neural network 108 can include an input layer 108a, one or more hidden layers 108b, and output layers 108c. The hidden layers 108b include one or more tensorized long short-term memory (LSTM) cells 200 (shown in FIG. 2) defined by the following algorithms:

Jₜ=tanh(Wₓ*xₜ+Wₕ⊗_{N}Hₜ₋₁+W_{corr}⊗_{N}Mₜ+bⱼ), Eq.1

(iₜ)^{T}=σ(Wᵢ_{ₜ}×[xₜ⊕vec(Hₜ₋₁)⊕vec(Mₜ)]+bᵢ_{ₜ}), Eq. 2

(fₜ)^{T}=σ(W_{f}_{ₜ}×[xₜ⊕vec(Hₜ₋₁)⊕vec(Mₜ)]+b_{f}_{ₜ}), Eq. 3

(oₜ)^{T}=σ(Wₒ_{ₜ}×[xₜ⊕vec(Hₜ₋₁)⊕vec(Mₜ)]+bₒ_{ₜ}), Eq. 4

Cₜ=mat(fₜ⊙vec(Cₜ₋₁)+iₜ⊙vec(Jₜ)), Eq. 5

Hₜ=mat(oₜ⊙tanh(vec(Cₜ))), Eq. 6

Regarding Eq. 1, N represents a number of sensors, Jₜ represents a cell updating matrix and b₃ represents a cell parameter. Wₓ represents a transition matrix and xₜ represents input data at time t, such that Wₓ*xₜ represents information from an input data. Wₕ represents a transition tensor, Hₜ₋₁ represents a hidden state matrix at time t−1 and ⊗_{N} denotes a tensor product along an axis of N, such that Wₕ⊗_{N}Hₜ₋₁ represents information from a previous hidden state. W_{corr} represents a transition tensor, Mₜ represents a variable correlation matrix at time t, such that W_{corr} ⊗_{N} Mₜ represents information from a correlation between multiple sensors.

Regarding Eq. 2, 3 and 4, iₜ, fₜ, and oₜ represent an input gate, forget gate and output gate, respectively, of a cell of the neural network, and T represents a number of time steps. σ( ) represents an element-wise sigmoid function, Wᵢ_{ₜ}, W_{f}_{ₜ} and Wₒ_{ₜ} represent weight parameters for iₜ, fₜ, or oₜ respectively, ⊕ denotes a concatenation operator, vec( ) denotes concatenating rows of a matrix into a vector, and bᵢ_{ₜ}, b_{f}_{ₜ} and bₒ_{ₜ} represent gate weight parameters for iₜ, fₜ, or oₜ respectively.

Regarding Eq. 5, Cₜ represents a cell state matrix at time t, mat( ) reshapes a vector into a matrix with dimensions of N×d, where d represents a dimensionality for each sensor, ⊙ denotes element-wise multiplication of vectors, and Cₜ₋₁ represents a cell state matrix at time t−1. In Eq. 6, Hₜ represents a hidden state matrix at time t.

The neural network 108, in accordance with embodiments the present invention, is configured to extract the temporal features for the time series data 104 from different sensors 102a, 102b, 102c. Thus, a neural network 108 having the cell 200 structure defined by Eq. 1 through 6, and described herein, can ensure that the learned hidden features, of the hidden layers 108b, for the various sensors 102a, 102b, 102c are independent. Specifically, the parameters for the inputs to the input layer 108a, at time t, can be specifically selected to maintain the independence of the learned hidden representations of the sensors 102a, 102b, 102c. As a result, further operations can be applied to the hidden representation of each sensor 102a, 102b, 102c. For example, in some embodiments, the hidden representations of each sensor 102a, 102b and 102c can be correlated to identify relationships and interactions between the sensors 102a, 102b, 102c. The correlation information provides embodiments of the present invention with the ability to deal with situations where the precursor event lies in the change in relationship between multiple sensors.

FIG. 2A provides a block representation of a cell 200 of the neural network 108 in accordance with an embodiment of the present invention. A previous cell state matrix (Cₜ₋₁) 210a, a previous state matrix (Hₜ₋₁) 212a, current time series data (xₜ) 201a, (e.g., time series data 104 shown in FIG. 1), and current variable correlation matrix (Mₜ) 201b are provided as inputs to the cell 200. A forget gate (fₜ) 202, input gate (iₜ) 204, and output gate (oₜ) 206 apply a sigmoid function, defined by Eq. 2, 3 and 4, to the inputs xₜ 201a, Hₜ₋₁ 212a and Mₜ 201b. Additionally, a cell updating matrix (Jₜ) is computed at block 208 based on Eq. 1 using the inputs xₜ 201a, Hₜ₋₁ 212a and Mₜ 201b.

The result of the forget gate (fₜ) 202 is applied to the previous cell state matrix (C_{f-1}), which has been concatenated into a vector, to de-emphasize information in the previous cell state, and outputs a forget cell state (c_{f}). The forget cell state vector (c_{f}) is added to a cell state update vector (c_{J}) generated from an element-wise multiplication of the input gate (iₜ) 204 with the cell updating matrix (Jₜ), defined in Eq. 1, which has been concatenated into a vector. The resulting vector from the addition of the forget cell state (c_{f}) and the cell state update vector (c_{J}) is reshaped into a matrix, and output as the cell state matrix (Cₜ) 210b.

The cell state matrix (Cₜ) 210b is also element-wise multiplied with the result of the output gate (oₜ) 206 to generate the hidden state matrix (Hₜ) 212b, as defined by Eq. 4. The hidden state matrix (Hₜ) 212b maintains a variable-wise data organization, such that each sensor 102a, 102b, 102c and its respective time series data 104 remain identifiable.

FIG. 2B provides a representation of the derivation of the cell updating matrix (Jₜ) 240. In the embodiment shown in FIG. 2B, there are two sensory variables (e.g., time series data corresponding to two sensors) 230 and 232. In FIG. 2 each sensory variable 230 and 232 has a dimensionality of four. However, other dimensionalities can be used as appropriate to encode the information in each individual sensory variable. Thus, some embodiments implement a current data input module 220 to apply a transition matrix Wₓ to each sensory variable 230 and 232, the current data input module 220 outputs the information embodied in the sensory variable 230 and 232, as tensorized current inputs 234 and 236. The tensorized current inputs 234 and 236 are provide as current time series input data 201a (shown in FIG. 2A).

Additionally, a tensor product of a transition tensor Wₕ and a previous hidden state matrix Hₜ 250 and 252 is generated in the hidden state input module 222. The hidden state input module 222 outputs a previous hidden state inputs 254 and 256. A correlation module 224, provided in some embodiments, generates a tensor product of a correlation matrix 260 and 262 and transition tensor W_{corr}. The correlation module 224 outputs correlation inputs 264 and 266.

The cell updating matrix module 240 combines the tensorized current inputs 234 and 236, the previous hidden state inputs 254 and 256, and correlation inputs 264 and 266 to generate a new cell updating matrix (Jₜ).

FIG. 2C depicts a block representation of the gate calculation process for the forget gate iₜ, input gate fₜ and the output gate oₜ as described above with respect to Eq. 2, Eq. 3 and Eq. 4, respectively.

Further, embodiments of the present invention can include, in addition to one or more cells 200 described above, other layers of neurons and weights. For example, embodiments can include one or more convolutional layers, pooling layers, fully connected layers, softmax layers, or any other appropriate type of neural network layer as hidden layers 108b of the neural network 108 shown in FIG. 1. Furthermore, hidden layers 108b can be added or removed as needed and the associated weights can be omitted or replaced with more complex forms of interconnections. Moreover, any number of hidden layers 108b can be implemented in embodiments of the present invention as needed and dictated by the particular application. For example, a weakly supervised multi-instance learning (MIL) framework can be included as one such hidden layer 108b in the neural network 108.

MIL assumes that a set of data instances (e.g., instance1 104h, instance2 104g and instance3 104f, as shown in FIG. 1) are grouped into bags (e.g., bag1 104d and bag2 104e, as shown in FIG. 1). Additionally, MIL assumes that bag-level labels are available, but instance-level labels are not. MIL aims to predict the label of a new bag 104d, 104e or an instance 104f, 104g, 104h. As shown in FIG. 1, a small segment of the time series data 104 (shown in FIG. 1) is considered as an instance 104f, 104g, 10fh. A bag 104d, 104e is a set of instances 104f, 104g, 10fh. MIL can be utilized to detect the instances that contain the precursors (in FIG. 1, the precursor events are shown in instance1 104h) by utilizing the labels of annotated anomalies 104j (shown in FIG. 1). However, the MIL itself does not consider the temporal pattern of time series data 104.

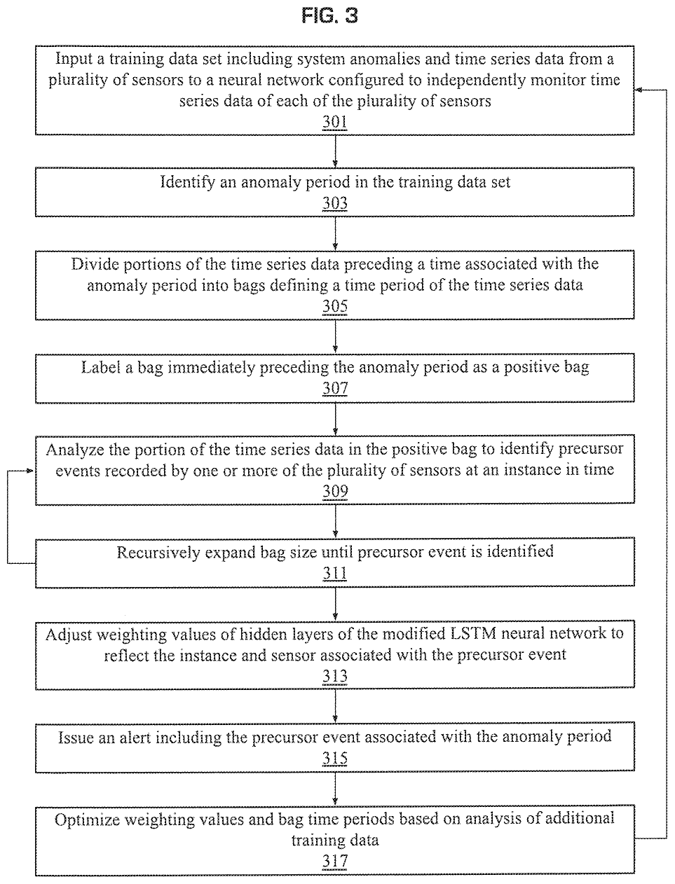

Turning to FIG. 3, with additional reference to FIG. 1, a flow diagram representing the training methodology for an embodiment of the anomaly precursor detection system 100 is shown. In an embodiment, the training is carried out using the MIL framework. The MIL considers time series data 104 in a larger time period as a bag 104d, 104e, and the data in a smaller time period is considered as an instance 104f, 104g, 104h. The bag immediately before a labeled anomaly period 104j, (e.g., bag2 104e in FIG. 1) is regarded as a positive bag; otherwise, the bag (e.g., bag1 104d) is regarded as a negative one. MIL assumes that the positive bag includes at least one positive instance (precursor), represented as instance1 104h in FIG. 1, and the instances of the negative bag 104d are all negative. The bags 104d, 104e and instances 104f, 104g, 104h can be overlapped, depending on the time periods defined for a bag and an instance, and the step sizes for bags and instances. During the learning process of MIL, the feature representation of the instance, e.g., instance1 104h, with the largest attention weight within a bag is used to represent the corresponding bag, e.g., bag2 104e.

The training process, shown in FIG. 3, begins at block 301 where a training dataset is input from a storage unit, such as a hard disk, or cloud storage, for example, to a neural network configured to independently monitor time series data of each of a plurality of sensors, such as the neural network shown in FIG. 2 and previously described. The training dataset includes system anomalies and time series data from the plurality of sensors.

At block 303, anomalies 104j (shown in FIG. 1) are identified in the training dataset, e.g., time series data 104 shown in FIG. 1, and labeled. Alternatively, the training datasets 104 can be configured to include prelabeled system anomalies 104j. The labels attached to the anomalies 104j can provide a description of the type of anomaly 104j. For example, in the context of a chemical processing plant, the labels can distinguish an anomaly 104j as: power overload, chemical leak, overheating, fire, etc. By way of another example, with respect to a computer network, the labels can distinguish an anomaly 104j as: system crash, unauthorized intrusion, overheating, Denial of Service (DOS) attack, etc.

At block 305, the portion of the training dataset 104 preceding a time associated with the anomaly 104j is divided into blocks (e.g., bags 104d, 104e) defining a time period of the time series data. The initial size of the bags 104d, 104e is set as a predefined value, and includes one or more instances 104f, 104g, 104h, which can be data points from the plurality of sensors (e.g., sensors 102a, 102b, 102c shown in FIG. 1) at a same instance in time.

The bag 104e immediately preceding the anomaly is labeled, at block 307, as a positive bag, and is assumed to include at least one instance 104h that predicts the onset of the anomaly, e.g., a precursor event. All other bags (e.g., bag1 104d) are labeled as negative bags at block 307.

Each instance 104f, 104g, 104h in the positive bag 104e is analyzed, at block 309, to identify precursor events recorded by one or more of the plurality of sensors 102a, 102b, 102c at an instance in time. If no precursor event is identified in the positive bag 104e at block 311, the initial bag size is expanded such that additional instances are included in the positive bag 104e. The learning process then returns to block 309 to analyze the instances included within the newly expanded positive bag 104e. Thus, the size, e.g., time period, of the positive bag 104e is recursively expanded until one or more instances 104h of a precursor event is identified. In this manner, the instances that predict the impending anomaly 104j can be located to model the precursor events.

In some cases, a precursor event can be defined by multiple events recorded by the sensors either during the same instance 104f, 104g, 104h or temporally proximate to one another. Additionally, the sensors involved in the precursor event can be spatially proximate as well. Thus, in some situations, the initial bag size can include only one sensor event of a plurality of sensor events that form the precursor event. Consequently, the precursor event may not be identified by the neural network until the bag size has been expanded to include constituent sensor events defining the precursor event. Once the neural network has identified a precursor event in the training dataset at block 311, the training process proceeds to block 313.

To model the temporal behavior of time series data 104 of each instance 104f, 104g, 104h, an LSTM network 108, shown in FIG. 1, with tensorized hidden states 108b can be employed in some embodiments. The time series data 104 of an instance 104f, 104g, 104h is fed into the tensorized LSTM network 108 to extract the features of the instance 104f, 104g, 104h. In embodiments, the tensorized LSTM network 108 incorporates a time-dependent correlation module 201b (shown in FIG. 2) to learn features encoding both temporal dynamics and the correlations between pairs of sensors 102a, 102b, 102c.

At block 313, the weighting values of hidden layers 108b of the neural network 108 are adjusted to reflect the instance(s) 104f, 104g, 104h and sensor(s) 102a, 102b, 102c associated with the precursor event. Additionally, the neural network 108 can be configured to issue an alert at block 315 that includes information regarding the precursor event (for example, sensor readings and time stamps) and the associated system anomaly 104j. The training process, as described with respect to blocks 301 through 315, is repeated for each additional training dataset at block 317. After successful processing of each training data set, the weighting values and bag time periods are further adjusted to maximize the success rate of the anomaly precursor detection system 100 at block 317.

In some embodiments, training can continue until all available training datasets are processed. In other embodiments, training can continue until the neural network 108 has surpassed a user defined, or application defined, success threshold. The success threshold can be dependent on the particular application to which the anomaly precursor detection system 100 is applied. For example, mission-critical applications, or applications in which an anomaly can affect the health of one or more individuals, can have a very high success threshold, e.g., 90% rate of reliably detecting an anomaly precursor. On the other hand, for less critical systems, the neural network 100 can be trained to meet a lower success threshold, for example 60% or 70%. In fact, any success threshold can be used based on the particular application to which embodiments of the present invention are applied.

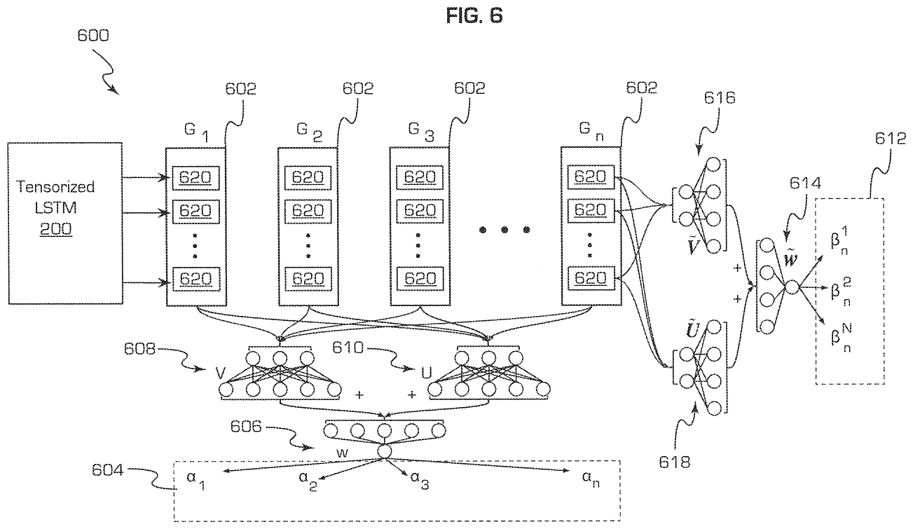

To detect the time location and sensor location of the precursor events, some embodiments implement a dual attention module (e.g., the dual attention module shown in FIG. 6) based on an attention mechanism with the output of a tensorized LSTM (e.g., cell 200) being used as an input. In some embodiments, the dual attention module is implemented as a separate neural network that is train jointly with the training of the tensorized LSTM 200. Other embodiments implement the dual attention module as additional hidden layer components combined with the tensorized LSTM 200 in a single neural network.

The dual attention module can pinpoint at which time instances the precursor symptoms show up, and what sensors are involved. In some embodiments, after the neural network model is trained, the future time series data 104 can be used by the neural network to automatically learn additional representations of precursor events, which can then be immediately used for determining whether an anomaly event is imminent.

In some embodiments, the tensorized LSTM 200 network includes a hidden state that encapsulates information exclusively from individual sensors (e.g., variables). Additionally, the hidden state can explicitly contain correlation information between sensors. Thus, the hidden features of the tensorized neural network, in some embodiments, allows leveraging the dual attention mechanism at a sensor level. Encapsulating the correlation information can allow embodiments to detect the precursor events predictive of an anomaly resulting from a correlation change between sensors.

In embodiments, the dual attention framework calculates an instance attention value for each instance 104f, 104g, 104h in the bag 104d, 104e; calculates a sensor attention value for each sensor 102a, 102b, 102c; and identifies correlations between multiple sensors 102a, 102b, 102c of the plurality of sensors 102a, 102b, 102c based on the instance attention value and sensor attention value, where the multiple sensors 102a, 102b, 102c are associated with the precursor event.

One embodiment of a dual attention framework 600 is defined by Eq. 7 and Eq. 8, below, and shown in FIG. 6. In FIG. 6, the output from a tensorized LSTM 200 is provided to the dual attention framework 600. The transformed representation of instance Eₖ (where k is the instance index) is denoted by Gₖ=(gₖ¹, . . . , gₖ^{N})^{T} 602, where, in some embodiments the blocks 620 can represent the feature representations for each variable (e.g., sensors 102a, 102b and 102c shown in FIG. 1). The following attention mechanism can be used to extract the instance attention values a 604 for different instances:

$${α}_{k} = \frac{exp \{ {w}^{⊤} ( tan h ( V {vec ( {G}_{k} )}^{⊤} ) ⊙ σ ( U {vec ( {G}_{k} )}^{⊤} ) ) \}}{{\sum }_{i = 1}^{n} exp \{ {w}^{⊤} ( tan {h ( V vec ( {G}_{k} ) )}^{⊤} ⊙ {σ ( U vec ( {G}_{i} ) )}^{⊤} ) \}} , \qquad Eq . 7$$

Where w 606, V 608, U 610 are parameters, for example, w 606 is a vector, V 608 and U 610 are matrices. These parameters can be viewed as parameters in a three-layer multiple layer perception (MLP). The three-layer MLP is used to infer the attention weights for each vector, e.g., vec(Gₖ), in a set of vectors. Also, n is the instance number of a bag, σ( ) is the gating mechanism part, and T is the transpose operator acting on the matrix or vector. To extract the sensor attention values βₖ^{l} 612 for different sensor data, the following attention mechanism can be applied:

$${β}_{k}^{l} = \frac{exp \{ {\tilde{w}}^{⊤} ( tan h ( {\tilde{V} ( {g}_{k}^{l} )}^{⊤} ) ⊙ σ ( {\tilde{U} ( {g}_{k}^{l} )}^{⊤} ) ) \}}{{\sum }_{i = 1}^{N} exp \{ {\tilde{w}}^{⊤} ( tan {h ( \tilde{V} ( {g}_{k}^{l} ) )}^{⊤} ⊙ {σ ( \tilde{U} ( {g}_{k}^{l} ) )}^{⊤} ) \} } , \qquad Eq . 8$$

Where \tilde{w} 614, \tilde{V} 616, Ũ 618 are parameters, for example, \tilde{w} 614 is a vector, \tilde{V} 616 and U 618 are matrices. These parameters can be viewed as parameters in a three-layer MLP. The three-layer MLP is used to infer the attention weights for each vector in a set of vectors. Additionally, N is the sensor number, and βₖ^{l} 612 indicates the attention values of the l-th sensor for the k-th instance.

Based on the transformed representation of instances 104f, 104g, 104h and the attention values 604 and 612, a transformed representation can be constructed for a bag 104d, 104e using an attention-based MIL pooling. The instance attention values 604 of the instances in a bag B={E₁, . . . , Eₙ} can be represented by α=(α₁, . . . , αₙ)^{T}. The instance 104f, 104g, 104h with the largest instance attention value 604 can be used to represent the whole bag 104d, 104e.

The sensor values for instance Eₖ*, where k* is the index of the representative instance, can be represented by β_{k*}=(β_{k*}¹, . . . , β_{k*}¹)^{T} 612. If the transformed representation of E_{k*} is G_{k*}=(gk1*, . . . , gkN*)^{T} 602, then the transformed representation of bag B can be derived as:

Q=G_{k*}β_{k*}=(g_{k*}¹β_{k*}¹, . . . ,g_{k*}^{N}β_{k*}^{N})^{T}, Eq. 9

In situations where multiple instances jointly characterize a precursor event, Eq. 9 can be expanded such that the bag 104d, 104e can be represented by Q=α₁(G₁β₁)+α₂(G₂β₂)+ . . . +αₙ (Gₙβₙ). Given the transformed representations of bags denoted by Q₁, . . . , Q_{M}, where M is the bag number, and the bag label Y₁, . . . , Y_{M}, the objective function of the neural network can be expressed as follows:

min J=J_{cont}+λJ_{reg}, Eq. 10

J_{cont}=Σ_{i,j}{(1−P_{i,j})½D_{i,j}²+P_{i,j}½{max(0,η−D_{i,j})}²} is an example of a bag pair contrastive loss function. i and j are the bag indices. P_{i,j} is the pair label, where P_{i,j}=1 if Yᵢ=Yⱼ; otherwise P_{i,j}=0. D_{i,j}=D(Qᵢ,Qⱼ) is an example of a bag distance. η is a threshold. By minimizing J_{cont}, the representations of bags 104d, 104e with the same label can be similar and the bags 104d, 104e with different labels can be dissimilar. In an embodiment, a contrastive loss function can be used because of its advantages in situations where the labeled data may be limited, which can be quite common in anomaly detection. However, in other embodiments, alternative loss functions can also be used, such as, for example, a triplet loss function.

J_{reg} is an example of a regularization term (e.g., L2 norm to w 606, V 608 and U 610) for parameters to learn the attention weights of the sensors 102a, 102b, 102c, e.g., \tilde{w}, \tilde{V}, Ũ in Eq. 8, and λ is a hyperparameter, determined by using cross-validation, having a value that can be predefined and independent of the training. For example, in an embodiment, ⅕ of the training set can be selected at random as a validation set to determine the best hyperparameter. J_{reg} can prevent parameters from overfitting. In detail, when two sensors are correlated with the anomaly event and display a similar pattern for the anomaly precursor, one of the two sensors may not be detected without J_{reg}.

The attention mechanism can be applied on the hidden feature representation of instances and the independent hidden feature representation of sensors. As a result, after the training process is completed, the weight for each instance and the weight for each sensor within an instance can be obtained.

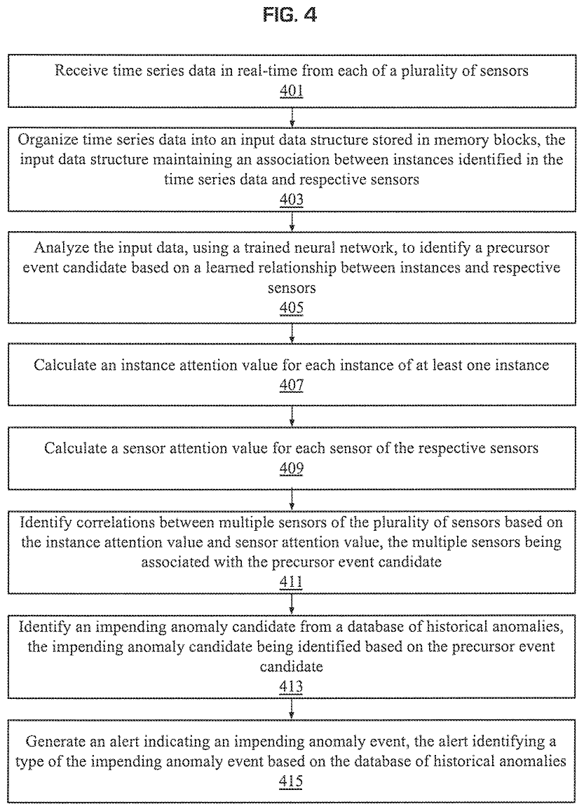

Referring to FIG. 4, an embodiment of a neural network implemented method for detecting anomaly precursor events is shown. The method begins at block 401 where time series data is received in real-time from each of a plurality of sensors. The sensors can be hardware sensors, software routines, or other components capable of measuring an operational parameter of a system being monitored.

At block 403, the time series data can be organized into an input data structure stored in memory blocks. The input data structure can be selected for its ability to maintain an association between instances identified in the time series data and respective sensors. In an embodiment, the input data structure is organized as a matrix data structure, in which each row of the matrix data structure corresponds to a respective sensor, and each column corresponds to a respective instance. Other appropriate data structures can be used provided that the data structure is capable of maintaining an association between each individual sensor and its corresponding time series data.

The input data matrix is analyzed, at block 405, using a trained neural network, (e.g., neural network 108 shown in FIG. 1) to identify a precursor event candidate based on a learned relationship between instances and respective sensors. The trained neural network 108 can be configured to maintain the addressability of the sensors and time series data.

As described previously, an embodiments of the present invention can maintain the sensor addressability with its corresponding time series data by using matrix data structures throughout the data analysis. However, in other embodiments sensor addressability can be realized using other data structures, data containers, or data organizing methods. Moreover, since each sensor 102a, 102b, 102c (shown in FIG. 1) is independent of the other sensors 102a, 102b, 102c, weightings can be adjusted and applied independently for each sensor 102a, 102b, 102c in the hidden layer 108b of the neural network 108. Consequently, sensors 102a, 102b, 102c that are most often associated with the onset of an anomaly can be emphasized during the analysis by having a larger weighting value assigned those sensors 102a, 102b, 102c, while sensors 102a, 102b, 102c that are not often associated with anomalies can be deemphasized using a smaller weighting value.

In some embodiments, the trained neural network 108 identifies at least one sensor and at least one instance involved in the precursor event candidate, calculating an instance attention value for each instance of at least one instance at block 407; and calculating a sensor attention value for each sensor of the respective sensors at block 409. Some embodiments can, then, identify correlations between multiple sensors 102a, 102b and 102c of the plurality of sensors 102a, 102b and 102c At block 411. The correlations can be identified at block 411 based on the instance attention value calculated in block 407 and the sensor attention value calculated in block 409, such that the multiple sensors 102a, 102b and 102c can be associated with the precursor event candidate.

Proceeding to block 413, the neural network 200 identifies an impending anomaly candidate from a database of historical anomalies. The impending anomaly candidate can be identified based on the precursor event candidate in the time series data 104. Once a precursor event candidate is identified, an alert 110 is generated at block 415, notifying a user of an impending anomaly in the system. In some embodiments, the alert can identify the type of anomaly of the impending anomaly event based on a match between historical precursor events and the precursor event candidate.

In some embodiments, the alert may further include procedures for preventing, alleviating or mitigating the impending anomaly. Thus, embodiments of the present invention can facilitate a rapid response to the impending anomaly to avoid the anomaly, or reduce the impact of and recovery time from the anomaly.

The tensorized LSTM neural network 108 in embodiments of the present invention can be local in time, which indicates the length of an input sequence, e.g. tensorized time series data 104, does not influence its storage needs. The time complexity per parameter can be a defined value for each time step. Thus, the overall complexity, of embodiments of the present invention, per time step is proportional to the number of parameters.

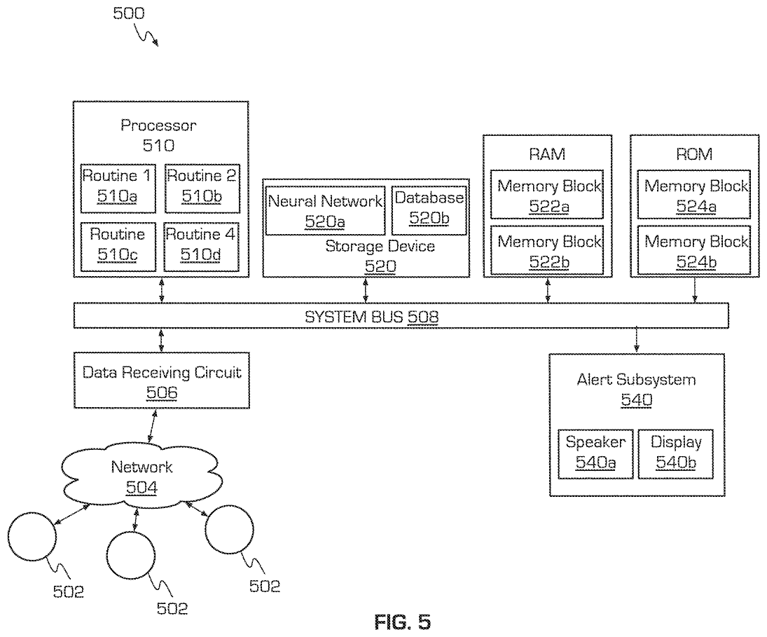

A neural network implemented anomaly precursor detection system is shown in FIG. 5. The system 500 includes a plurality of sensors 502 (e.g., sensors 102a, 102b and 102c shown in FIG. 1) that transmit time series data to the system 200 by way of a data receiving circuit 506 connected to the sensors 502 via a network 504, for example the Internet. The data receiving circuit 506, a processor 510, a storage device 520, Ram 522, ROM 524 and an alert subsystem 540 can be interconnected and in electrical communication with one another via a system bus 508.

The time series data received by the data receiving circuit 506 can be stored in one or more memory block 522a and 522b disposed in, for example, RAM 522, or in the storage device 520. The storage device 520, RAM 522 and ROM 524 collectively provide storage for the data and processor-executable instruction code of embodiments of the present invention. As appropriate, data and instruction code can be stored in any one of the storage device 520, RAM 522 and ROM 524, and thus the storage device 520, RAM 522 and ROM 524 can be used interchangeably. For example, a database of historical anomalies 520b can be stored in the storage device 520, while some instruction code can be stored in memory blocks 524a and 524b of the ROM 524 and other instruction code and received data can be stored in the memory blocks 522a and 522b of RAM 522. Moreover, additional storage types may be provided, such as off-site cloud storage, flash memory and/or cache memory, for example.

The processor 510, which can be a central processing unit (CPU), a field programmable gate array (FPGA), application specific integrated circuit (ASIC), or any other circuit configured to implement, e.g., execute, a data organizing routine (e.g., routine 1 510a), a data analysis routine (e.g., routine 2 510b), an anomaly identification routine (e.g., routine 3 510c), and a dual attention mechanism (e.g., routine 4 510d). The data organizing routine 510a organizes time series data into an input data structure stored in memory blocks 522a and 522b. The input data structure maintains an association between instances identified in the time series data and respective sensors 502. The data analysis routine 510b analyzes the input data, using a trained neural network 520a provided in the storage device 520, to identify a precursor event candidate based on a learned relationship between instances and respective sensors 502. The anomaly identification routine 510c identifies an impending anomaly candidate from the database of historical anomalies 520b. The impending anomaly candidate can be identified based on the precursor event candidate identified by the data analysis routine 510b.

The dual attention mechanism 510d can be configured to identify at least one sensor and at least one instance involved in the precursor event candidate. Specifically, the dual attention mechanism 510d calculates an instance attention value (604 shown in FIG. 6) for each instance of at least one instance; calculates a sensor attention value (612 shown in FIG. 6) for each sensor of the plurality of sensors 502; and identifies correlations between multiple sensors 502 of the plurality of sensors 502 based on the instance attention value 604 and sensor attention value 612. The multiple sensors 502 can be, thus, associated with the precursor event candidate.

The alert subsystem 540 is configured to generate an alert, such as an audio alert via a speaker 540a and/or a visual alert displayed on a display device 540b, for example. The alert can be configured to indicate an impending anomaly event, identify a type of the impending anomaly event based on the database of historical anomalies 522b. Moreover, in some embodiments the alert subsystem 540 can provide instructions, based on the type of anomaly, for preventing the onset of the impending anomaly or mitigate its effects.

Of course, the processing system 500 may also include other elements (not shown), as well as omit certain elements. For example, user input/output (I/O) devices, e.g., keyboards, touchpad, mouse, touchscreen or speech recognition control system, can be included in the system 500, depending upon the particular implementations and application of embodiments of the present invention. For example, various types of wireless and/or wired input and/or output devices can be used. Moreover, additional processors, controllers, memories, and so forth, in various configurations can also be utilized. These and other variations of the system 500, as dictated by the needs of particular applications, can be considered as embodiments of the present invention.

In an embodiment, the data receiving circuit 506 is configured to receive time series data from a plurality of sensors 502 in substantially real-time. The data receiving circuit 506 can be a network adapter coupled to sensors 502 over a network 504, such as, for example, a local area network (LAN), wide area network (WAN), or the Internet. Alternatively, the sensors 502, which can include multiple sensors of various types disposed at various locations throughout a monitored system, can be coupled to the data receiving circuit 508 by way of a wired serial connection, such as RS-232, or a wireless serial connection, such as Bluetooth®. In applications where the sensor 502 is a software routine or module, the data receiving circuit 506 may be implemented as RAM 522, or other hardware or software implemented data storage configured to receive a real-time data stream.

Embodiments described herein may be entirely hardware, entirely software or including both hardware and software elements.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for detecting anomaly precursor events, comprising:
organizing time series data into an input data structure stored in memory blocks, the input data structure maintaining an association between instances identified in the time series data and respective sensors;
calculating an instance attention value for each instance of at least one instance;
calculating a sensor attention value for each sensor of the respective sensors;
identifying correlations between multiple sensors of the respective sensors based on the instance attention value and sensor attention value, the multiple sensors being associated with the precursor event candidate, to identify a precursor event candidate based on a learned relationship between the instances and the respective sensors;
identifying an impending anomaly candidate from a database of historical anomalies, the impending anomaly candidate being identified based on the precursor event candidate; and
generating an alert indicating an impending anomaly event, the alert identifying a type of impending anomaly event based on the database of historical anomalies.

2. The method of claim 1, wherein associations between respective sensors and time series data are preserved in a trained neural network.

3. The method of claim 2, further comprising identifying at least one sensor and at least one instance involved in the precursor event candidate.

4. The method of claim 3, wherein the trained neural network includes a cell having a cell update matrix, Jₜ, defined as: Jₜ=tanh(Wₓ*xₜ+Wₕ⊗_{N}Hₜ₋₁+W_{corr}⊗_{N}Mₜ+bⱼ), where N represents a number of sensors, bⱼ represents a cell parameter, Wₓ*xₜ represents information from an input data, ⊗_{N} denotes a tensor product along an axis of N, Wₕ⊗_{N}Hₜ₋₁ represents information from a previous hidden state including associations between sensors and corresponding time series data, and W_{corr}⊗_{N}Mₜ represents information from a correlation between multiple sensors.

5. The method of claim 4, wherein the cell includes:
an input gate, iₜ, defined as: (iₜ)^{T}=σ(Wᵢ_{ₜ}×[xₜ ⊕vec(Hₜ₋₁)⊕vec(Mₜ)]+bᵢ_{ₜ}),
a forget gate, fₜ, defined as (fₜ)^{T}=σ(Wᵢ_{ₜ}×[xₜ⊕vec(Hₜ₋₁)⊕vec(Mₜ)]+bᵢ_{ₜ}), and
an output gate, oₜ, defined by: (oₜ)^{T}=σ(Wₒ_{ₜ}×[xₜ⊕vec(Hₜ₋₁)⊕vec(Mₜ)]+bₒ_{ₜ}),
where T represents a number of time steps, σ( ) represents an element-wise sigmoid function, W represents a weighting parameter for iₜ, fₜ, or oₜ, ⊕ denotes a concatenation operator, vec( ) denotes concatenating rows of a matrix into a vector, and b represents a gate parameter for iₜ, fₜ, or oₜ.

6. The method of claim 5, wherein the cell includes a cell state matrix Cₜ defined as:
Cₜ=mat(fₜ⊙vec(Cₜ₋₁)+iₜ⊙vec(Jₜ)), where mat( ) reshapes a vector into a matrix, ⊙ denotes element-wise multiplication of vectors, and Cₜ₋₁ represents a cell state matrix at time t−1.

7. The method of claim 6, wherein the cell includes a hidden state matrix Hₜ defined as:
Hₜ=mat(oₜ⊙tanh(vec(Cₜ))).

8. An anomaly precursor detection system, comprising:
a data receiving circuit configured to receive time series data from a plurality of sensors in substantially real-time;
a storage circuit configured to store the time series data from the plurality of sensors received via the data receiving circuit;
a processor device configured to implement:
a data organizing routine configured to organize time series data into an input data structure stored in memory blocks, the input data structure maintaining an association between instances identified in the time series data and respective sensors,
a data analysis routine configured to analyze the input data, using a trained neural network that preserves associations between respective sensors and time series data, to identify a precursor event candidate based on a learned relationship between instances and respective sensors,
an anomaly identification routine configured to identify an impending anomaly candidate from a database of historical anomalies, the impending anomaly candidate being identified based on the precursor event candidate, and
an alert subsystem configured to generate an alert indicating an impending anomaly event, the alert identifying a type of the impending anomaly event based on the database of historical anomalies.

9. The system of claim 8, wherein the processor is further configured to implement a dual attention mechanism configured to identify at least one sensor and at least one instance involved in the precursor event candidate.

10. The system of claim 9, wherein the dual attention mechanism:
calculates an instance attention value for each instance of at least one instance;
calculates a sensor attention value for each sensor of the plurality of sensors; and
identifies correlations between multiple sensors of the plurality of sensors based on the instance attention value and sensor attention value, the multiple sensors being associated with the precursor event candidate.

11. The system of claim 10, wherein the neural network includes a cell having a cell update matrix defined by:
Jₜ=tanh(Wₓ*xₜ+Wₕ⊗_{N}Hₜ₋₁+W_{corr}⊗_{N}Mₜ+bⱼ),
where N represents a number of sensors, b₃ represents a cell parameter, Wₓ*xₜ represents information from an input data, ⊗_{N} denotes a tensor product along an axis of N, Wₕ⊗_{N}Hₜ₋₁ represents information from a previous hidden state, W_{corr}⊗_{N}Mₜ represents information from a correlation between multiple sensors.

12. The system of claim 11, wherein the cell has an input gate iₜ, a forget gate fₜ and an output gate oₜ defined by:
(iₜ,fₜ,oₜ)^{T}=σ(W_{gate}×[xₜ⊕vec(Hₜ₋₁)⊕vec(Mₜ)]+b_{gate}),
where T represents a number of time steps, σ( ) represents an element-wise sigmoid function, W_{gate} represents a parameter for iₜ, fₜ, or oₜ, ⊕ denotes a concatenation operator, vec( ) denotes concatenating rows of a matrix into a vector, and b_{gate} represents a gate parameter for iₜ, fₜ, or oₜ.

13. The system of claim 12, wherein the cell includes a cell state matrix Cₜ defined by:
Cₜ=mat(fₜ⊙vec(Cₜ₋₁)+iₜ⊙vec(Jₜ)),
where mat( ) reshapes a vector into a matrix, ⊙ denotes element-wise multiplication of vectors, and Cₜ₋₁ represents a cell state matrix at time t−1.

14. The system of claim 13, wherein the cell includes a hidden state matrix Hₜ defined by:
Hₜ=mat(oₜ⊙tanh(vec(Cₜ))).

15. A non-transitory computer readable storage medium comprising a computer readable program for anomaly precursor detection, wherein the computer readable program, when executed by a processor device, causes the processor device to perform the method of:
organizing time series data into an input data structure stored in memory blocks, the input data structure maintaining an association between instances identified in the time series data and respective sensors;
analyzing the input data, using a trained neural network that preserves associations between respective sensors and time series data, to identify a precursor event candidate based on a learned relationship between instances and respective sensors;
identifying an impending anomaly candidate from a database of historical anomalies, the impending anomaly candidate being identified based on the precursor event candidate; and
generating an alert indicating an impending anomaly event, the alert identifying a type of the impending anomaly event based on the database of historical anomalies.

16. The method of claim 15, further comprising identifying at least one sensor and at least one instance involved in the precursor event candidate.

17. The method of claim 16, wherein identifying at least one sensor and at least one instance involved in the precursor event candidate includes:
calculating an instance attention value for each instance of at least one instance;
calculating a sensor attention value for each sensor of the plurality of sensors; and
identifying correlations between multiple sensors of the plurality of sensors based on the instance attention value and sensor attention value, the multiple sensors being associated with the precursor event candidate.

18. The method of claim 17, wherein the neural network includes a cell having a cell update matrix defined by:
Jₜ=tanh(Wₓ*xₜ+Wₕ⊗_{N}Hₜ₋₁+W_{corr}⊗_{N}Mₜ+bⱼ),
where N represents a number of sensors, b₃ represents a cell parameter, Wₓ*xₜ represents information from an input data, ⊗_{N} denotes a tensor product along an axis of N, Wₕ⊗_{N}Hₜ₋₁ represents information from a previous hidden state, W_{corr}⊗_{N}Mₜ represents information from a correlation between multiple sensors.

19. The method of claim 18, wherein the cell has an input gate iₜ, a forget gate fₜ and an output gate oₜ defined by:
(iₜ,fₜ,oₜ)^{T}=σ(W_{gate}×[xₜ⊕vec(Hₜ₋₁)⊕vec(Mₜ)]+b_{gate}),
where T represents a number of time steps, σ( ) represents an element-wise sigmoid function, W_{gate} represents a parameter for iₜ, fₜ, or oₜ, ⊕ denotes a concatenation operator, vec( ) denotes concatenating rows of a matrix into a vector, and b_{gate} represents a gate parameter for iₜ, fₜ, or oₜ.

20. The method of claim 19, wherein the cell includes:
a cell state matrix Cₜ defined by: Cₜ=mat(fₜ⊙vec(Cₜ₋₁)+iₜ⊙vec(Jₜ)),
where mat( ) reshapes a vector into a matrix, ⊙ denotes element-wise multiplication of vectors, and Cₜ₋₁ represents a cell state matrix at time t−1; and
a hidden state matrix Hₜ defined by: Hₜ=mat(oₜ⊙tanh(vec(Cₜ))).
